(19) United States
(12) Patent Application Publication
(10) Pub. No.: US 2012/0050573 A1
(43) Pub. Date: Mar. 1, 2012

(54) IMAGE PICKUP APPARATUS

(75) Inventor: Nagahiro Kawaguchi, Kobe-shi (JP)

(73) Assignee: SANYO ELECTRIC CO., LTD., Osaka (JP)

(21) Appl. No.: 13/217,822

(22) Filed: Aug. 25, 2011

(30) Foreign Application Priority Data
Sep. 1, 2010 (JP) 2010-195921

(51) Int. Cl. H04N 5/76

(52) U.S. Cl. 348/231.99; 348/E05.031

(57) ABSTRACT

A digital camera includes a substrate; a signal processing unit fixed to the substrate and generating image data; a card socket to which an external memory card storing the image data generated by the signal processing unit is removably attached; and a built-in memory fixed to the card socket and storing the image data generated by the signal processing unit.

This nonprovisional application is based on Japanese Patent Application No. 2010-195921 filed on Sep. 1, 2010 with the Japan Patent Office, the entire contents of which are hereby incorporated by reference.

### BACKGROUND OF THE INVENTION

1. Field of the Invention

The present invention relates to an image pickup apparatus, and particularly to an image pickup apparatus provided with a removable storage medium and having a storage medium embedded therein.

2. Description of the Related Art

An image pickup apparatus such as a digital camera and a digital video camera is known. In the digital camera and the digital video camera, image data is obtained using an image pickup device such as a CCD (Charge Coupled Device), for example. The obtained image data is processed as appropriate, and then, stored in the memory built in the image pickup apparatus and in the external memory such as a memory card.

For example, the memory card is removably attached to a card socket provided in the image pickup apparatus. The built-in memory is mounted together with various electronic devices on a substrate.

However, when the built-in memory is fixed together with various electronic devices on the substrate, not only the built-in memory and the electronic devices but also wiring for connecting the built-in memory and the electronic devices to each other should be arranged within the limited space in the substrate. Accordingly, the analog circuit of the image pickup system on the substrate may be located in close proximity, for example, to the wiring (an analog/data bus and the like) connected to the built-in memory. In this case, the noise produced due to access to the built-in memory may be superimposed on the analog circuit.

### SUMMARY OF THE INVENTION

An image pickup apparatus includes a substrate; a processing unit that is fixed to the substrate and generates image data; a mounting portion to which an external memory storing the image data generated by the processing unit is removably attached; and a built-in memory that is fixed to the mounting portion and stores the image data generated by the processing unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of the external appearance of an example of an image pickup apparatus.

FIG. 2 is a block diagram illustrating the internal configuration of the digital camera in FIG. 1.

FIG. 3 is a perspective view of a card socket.

FIG. 4 is a front view of the card socket.

### DESCRIPTION OF THE PREFERRED EMBODIMENTS

The embodiments of the present invention will be hereinafter described with reference to the accompanying drawings, in which the same components are designated by the same reference characters and have the same names and functions. Accordingly, detailed description thereof will not be repeated.

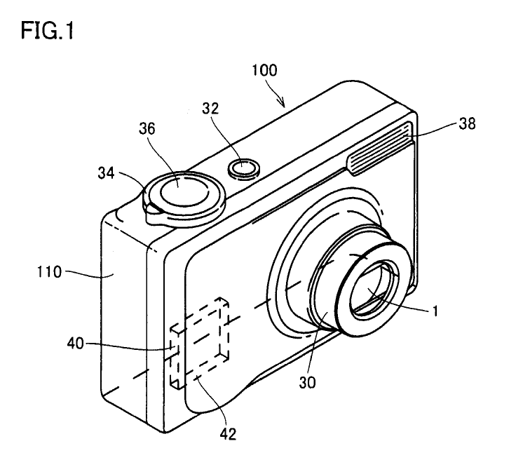

FIG. 1 is a perspective view of the external appearance of an example of an image pickup apparatus according to the present embodiment. A digital camera 100 serving as an image pickup apparatus according to the present embodiment includes a camera body 110. It is to be noted that a digital video camera may be used as an image pickup apparatus in place of digital camera 100. In addition, the type of image pickup apparatus is not limited to a digital camera and a digital video camera. A mobile phone, a personal digital assistant and the like equipped with a camera may also be used as an image pickup apparatus.

Camera body 110 has a front surface provided with a lens barrel 30 having an image pickup lens 1 incorporated therein. Lens barrel 30 is a collapsible barrel and has a movable barrel which is doubly nested. When the user turns on a power button 32, the drive motor causes the movable barrel to extend from camera body 110 to the image shooting state position shown in FIG. 1. Then, when power button 32 is turned off in this state, the drive motor causes the movable barrel to be retracted into camera body 110, that is, brought into a collapsed state.

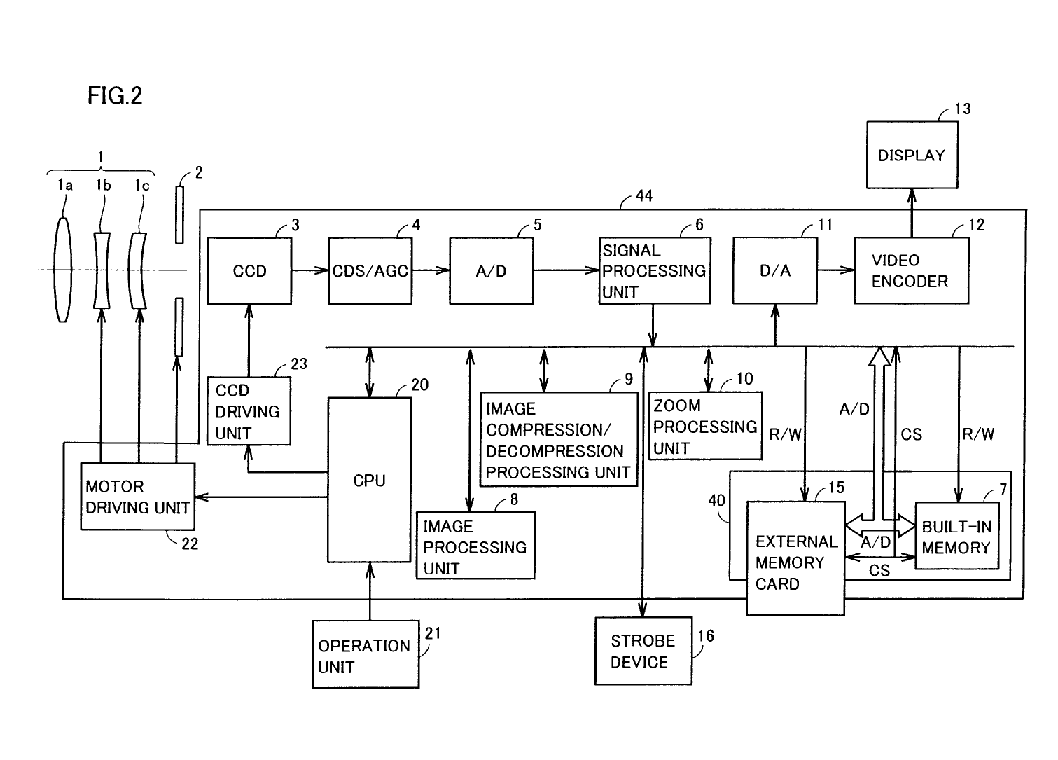

In addition to lens barrel 30, a strobe light emitting window 38 is provided on the front surface of camera body 110. Camera body 110 has an upper surface provided with power button 32, a mode dial 34 and a release button 36. Furthermore, camera body 110 also has a bottom provided with a cover (not shown) that is freely opened and closed to cover a USB connector or an insertion slot 42 of a card socket 40 into which the external memory card (for example, an SD memory card) 15 (FIG. 2) capable of being attached to and detached from digital camera 100 is removably inserted.

Mode dial 34 is operated to rotate, which allows switching among the still image shooting mode for shooting a still image, the moving image shooting mode for shooting a moving image, the reproduction mode for displaying the shot image on a display 13 (FIG. 2), and the setting mode for performing various settings.

Release button 36 acts as a switch that is pressed in two steps. When release button 36 is lightly pressed (pressed halfway) down after the object to be shot is framed, various image shooting preparation processes such as determination of the exposure condition and automatic focus adjustment are carried out. When release button 36 is then strongly pressed (fully pressed) down in this state, a picture is taken under the determined exposure condition and in the adjusted focal distance.

FIG. 2 is a block diagram illustrating the internal configuration of digital camera 100 in FIG. 1.

Referring to FIG. 2, digital camera 100 includes image pickup lens 1, a diaphragm mechanism 2, an image pickup device (CCD) 3, a CDS/AGC circuit 4, an A/D converter 5, a signal processing unit 6, a built-in memory (for example, an SDRAM: Synchronous Dynamic Random Access Memory) 7, an image processing unit 8, an image compression/decompression processing unit 9, a zoom processing unit 10, a D/A converter 11, a video encoder 12, a display 13, a strobe device 16, a CPU 20, an operation unit 21, a motor driving unit 22, a CCD driving unit 23, and a card socket 40.

In the present embodiment, card socket 40 is mounted together with various electronic devices and electronic circuits on the same substrate 44. For example, CCD 3, CDS/AGC circuit 4, A/D converter 5, signal processing unit 6, image processing unit 8, image compression/decompression processing unit 9, zoom processing unit 10, D/A converter 11, video encoder 12, CPU 20, motor driving unit 22, CCD driving unit 23, and card socket 40 are mounted on the same substrate 44. It is to be noted that the electronic devices and electronic circuits that are mounted together with card socket 40 on substrate 44 are not limited thereto. Card socket 40 and at least one of CCD 3, CDS/AGC circuit 4, A/D converter 5, signal processing unit 6, image processing unit 8, image compression/decompression processing unit 9, zoom processing unit 10, D/A converter 11, video encoder 12, CPU 20, motor driving unit 22, and CCD driving unit 23 may be mounted on the same substrate 44.

Image pickup lens 1 consists of a main lens 1a, a zoom lens 1b and a focus lens 1c. Diaphragm mechanism 2 is located behind image pickup lens 1. Zoom lens 1b, focus lens 1c and diaphragm mechanism 2 each have a motor connected thereto. Each of these motors is a stepping motor, and the operation of each of these motors is controlled by the drive pulse transmitted from motor driving unit 22 connected to CPU 20.

CCD 3 is located behind diaphragm mechanism 2. A timing generator (not shown) controlled by CPU 20 is connected to CCD 3 through CCD driving unit 23. CCD driving unit 23 controls the accumulated charge amount and the charge reading timing of each cell in CCD 3 based on the timing signal that is input from the timing generator.

In digital camera 100 in FIG. 2, the optical image in the field to be photographed is projected through image pickup lens 1 and diaphragm mechanism 2 on the light-receiving surface, that is, the image pickup surface, of CCD 3. Diaphragm mechanism 2 adjusts the amount of the light that passes through image pickup lens 1.

By photoelectric conversion, CCD 3 generates charge, that is, a Raw image signal, corresponding to the lightness and the darkness of the optical image in the field to be photographed that is formed on the image pickup surface. Other than a CCD, a CMOS (Complementary Metal-Oxide Semiconductor) is used as an image pickup device.

The output signal (RGB signal) from CCD 3 is transmitted to CDS/ADC circuit 4 including a CDS circuit and an AGC circuit. After the output signal of CCD 3 that is input into CDS/ADC circuit 4 is subjected to the correlated double sampling processing in the CDS circuit, the resultant output signal is subjected to gain adjustment to oscillate with an optimum amplitude in the AGC circuit. The output signal of CDS/ADC circuit 4 is converted into a digital video signal by A/D converter 5. The digital video signal obtained by A/D converter 5 is transmitted to signal processing unit 6 and subjected to a predetermined signal processing (white balance adjustment, color separation, YUV conversion, and the like), which causes the signal to be converted into image data in YUV format. The image data produced by signal processing unit 6 is stored in built-in memory 7 or an external memory card 15 of digital camera 100. The image data stored in built-in memory 7 or external memory card 15 may be read from built-in memory 7 or external memory card 15 for reproduction on display 13, or may be read from built-in memory 7 or external memory card 15 for transfer to the device located outside of digital camera 100 through connection using a USB (Universal Serial Bus). The format of the storage medium is not limited to an SDRAM and an SD memory card, but any storage media other than these may be used.

Built-in memory 7 and external memory card 15 are connected to each other through an address/data (A/D) bus and a chip select (CS) signal line. In the present embodiment, the data can be transferred between built-in memory 7 and external memory card 15. The address/data bus and the chip select signal line are connected also to the signal processing circuit including signal processing unit 6, CPU 20 and the like.

A read/write signal and a chip select signal are used to perform recording of the image data in built-in memory 7 or external memory card 15, reading of the image data from built-in memory 7 or external memory card 15, and transfer of the image data between built-in memory 7 and external memory card 15.

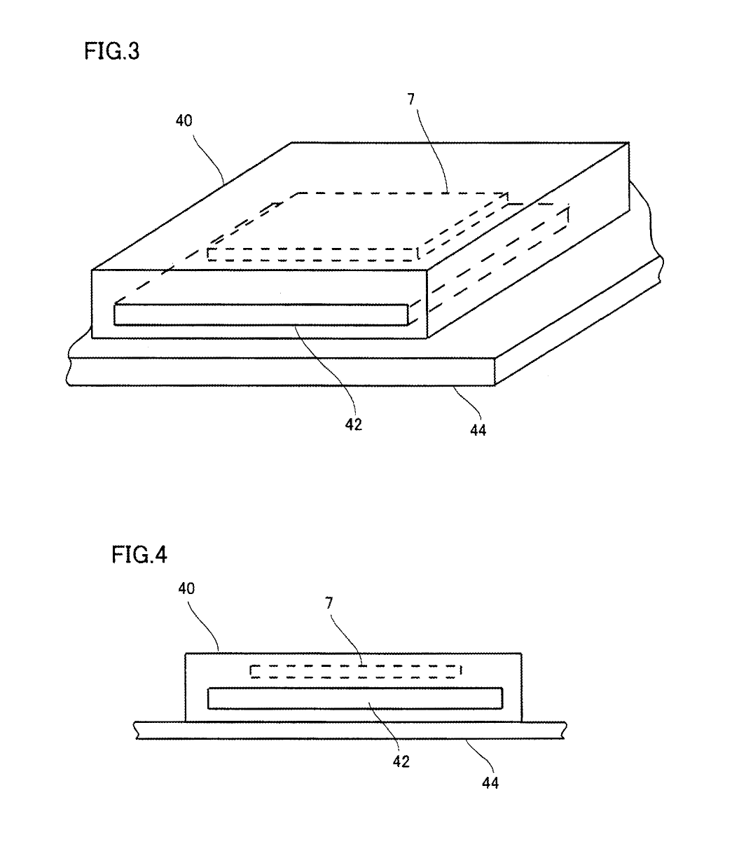

As described above, external memory card 15 is removably attached to card socket 40. Built-in memory 7 is fixed to card socket 40. More specifically, as shown in FIG. 3, built-in memory 7 is embedded within card socket 40. For example, as shown in FIG. 4, built-in memory 7 is embedded in the space provided between the end face and insertion slot 42 of card socket 40. It is to be noted that the position in which built-in memory 7 is fixed is not limited thereto.

As described above, in the present embodiment, built-in memory 7 is mounted not on substrate 44 but in card socket 40 to which external memory card 15 is inserted. Accordingly, built-in memory 7 can be mounted in digital camera 100 without having to ensure the space on substrate 44 for mounting built-in memory 7. Consequently, the space on substrate 44 required for mounting electronic devices can be reduced by the area corresponding to built-in memory 7.

Since the space for mounting built-in memory 7 can be reduced, the space used for providing wiring on the substrate can be increased by the area corresponding to built-in memory 7. Accordingly, the wiring can be arranged such that the distance between the analog circuits such as CDS/ADC circuit 4 and the wiring such as an address/data bus on the substrate is increased as compared to the case where built-in memory 7 is disposed on the substrate. Consequently, the interference with the analog circuit resulting from the noise generated in the address/data bus can be suppressed.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image pickup apparatus comprising:
a substrate;
a processing unit that is fixed to said substrate and generates image data;
a mounting portion to which an external memory storing the image data generated by said processing unit is removably attached; and
a built-in memory that is fixed to said mounting portion and stores the image data generated by said processing unit.

2. The image pickup apparatus according to claim 1, wherein said mounting portion is fixed to said substrate.

3. The image pickup apparatus according to claim 1, wherein said built-in memory is embedded within said mounting portion.
